(19) United States
(12) Patent Application Publication
(10) Pub. No.: US 2025/0379409 A1
(43) Pub. Date: Dec. 11, 2025

(54) RADIO FREQUENCY CONNECTOR AND RADIO FREQUENCY CONNECTION DEVICE

(71) Applicant: Wistron NeWeb Corporation, Hsinchu (TW)

(72) Inventor: Shih-Ping WU, Hsinchu (TW)

(21) Appl. No.: 18/888,200

(22) Filed: Sep. 18, 2024

(30) Foreign Application Priority Data
Jun. 6, 2024 (TW) 113120963

(51) Int. Cl. H01R 43/02; H01R 13/02; H01R 24/20

(52) U.S. Cl. CPC H01R 43/0235; H01R 13/025; H01R 24/20; H01R 43/0263; H01R 2201/24

(57) ABSTRACT

The present disclosure provides a radio frequency connector. The radio frequency connector is configured to connect a radio frequency cable. The radio frequency cable includes a core wire and a metal covering layer insulated to each other. The radio frequency connector includes a first main body, a second main body, and an insulating body. The first main body includes a first accommodating space and a first opening. The first opening allows a first solder to enter the first accommodating space to contact the core wire so as to electrically connect the core wire and the first main body. The second main body includes a second accommodating space and a second opening. The second opening allows a second solder to enter the second accommodating space to contact the metal covering layer so as to electrically connect the metal covering layer and the second main body.

### RELATED APPLICATIONS

This application claims the benefit of priority to Taiwan Patent Application No. 113120963, filed on June 06, 2024. The entire content of the above identified application is incorporated herein by reference.

### BACKGROUND

### TECHNICAL FIELD

The present disclosure relates to a connector and a connection device, in particular to a radio frequency connector and a radio frequency connection device.

### DESCRIPTION OF RELATED ART

In the field of electronic communications, radio frequency (RF) cables are frequently configured to transmit signals. The advantages of using RF cables for signal transmission are their excellent anti-interference ability and low signal loss. These RF cables can be connected to RF components to radiate signals.

To effectively radiate the signals of the RF cables, solder is configured to connect the core wire and the braided mesh of the RF cables to different solder points of the RF components, allowing them to cooperate in radiating the RF cable signals.

During the soldering process, the core wire and braided mesh must be accurately positioned and fixed to different solder points of the RF component before soldering. However, these solder points are mostly not in the same linear position as the length extension direction of the RF cable, requiring the RF cable to be bent before soldering, which makes the automated soldering process more difficult.

Therefore, how to avoid the manual bending process that leads to low production efficiency has become a goal pursued by related industries.

### SUMMARY

The present disclosure provides a radio frequency connector and a radio frequency connection device. Through the structural configuration of the radio frequency connector, it helps connect the radio frequency cable to the radio frequency component, thereby improving production efficiency.

According to an embodiment of the present disclosure, a radio frequency connector is provided. The radio frequency connector is configured to connect a radio frequency cable including a core wire and a metal covering layer insulated from each other. The radio frequency connector includes a first main body, a second main body, and an insulating body. The first main body includes a first accommodating space and a first opening. The first accommodating space is for accommodating the core wire. The first opening communicates with the first accommodating space, and the first opening allows a first solder to enter the first accommodating space to contact the core wire, thereby electrically connecting the core wire with the first main body. The second main body includes a second accommodating space and a second opening. The second accommodating space is for accommodating the metal covering layer. The second opening communicates with the second accommodating space, and the second opening allows a second solder to enter the second accommodating space to contact the metal covering layer, thereby electrically connecting the metal covering layer with the second main body. The insulating body connects the first main body and the second main body to insulate the first main body and the second main body from each other.

According to another embodiment of the present disclosure, a radio frequency connection device is provided. The radio frequency connection device is applied to connect a radio frequency cable and a radio frequency component. The radio frequency cable is configured to electrically connect the radio frequency component and includes a core wire and a metal covering layer insulated from each other. The radio frequency connection device includes a radio frequency connector and a jig body. The radio frequency connector is disposed on the radio frequency component and includes a first main body and a second main body. The first main body includes a first accommodating space and a first opening. The first accommodating space is for accommodating the core wire. The first opening communicates with the first accommodating space, and the first opening allows a first solder to enter the first accommodating space to contact the core wire, thereby electrically connecting the core wire with the first main body. The second main body includes a second accommodating space and a second opening. The second accommodating space is for accommodating the metal covering layer. The second opening communicates with the second accommodating space, and the second opening allows a second solder to enter the second accommodating space to contact the metal covering layer, thereby electrically connecting the metal covering layer with the second main body. The jig body includes a base and a cover. The base includes a placement area for placing the radio frequency component and the radio frequency cable. The cover is connected to the base and includes an upper introduction groove facing the base, and a depth of the upper introduction groove gradually narrows toward the radio frequency connector. The radio frequency cable enters the radio frequency connector along the upper introduction groove.

Therefore, the core wire can be connected to a first solder point of the radio frequency component through the first main body, and the metal covering layer can be connected to a second solder point of the radio frequency component through the second main body without additional bending, solving the problem of low productivity caused by the manual bending step.

### BRIEF DESCRIPTION OF THE DRAWINGS

The described embodiments may be better understood by reference to the following description and the accompanying drawings, in which:

FIG. 1 is a perspective view of a radio frequency connector according to an embodiment of the present disclosure.

FIG. 2 is an exploded view of the radio frequency connector of the embodiment shown in FIG. 1.

FIG. 3 is a top view of the radio frequency connector connecting to a radio frequency cable according to the embodiment shown in FIG. 1.

FIG. 4 is a cross-sectional view of the radio frequency connector and the radio frequency cable according to the embodiment shown in FIG. 1.

FIG. 5 is a perspective view of a radio frequency connection device applied to a radio frequency cable and a radio frequency component according to another embodiment of the present disclosure.

FIG. 6 is an exploded view of the radio frequency connection device applied to the radio frequency cable and the radio frequency component according to the embodiment shown in FIG. 5.

FIG. 7 is a perspective view of a radio frequency connection device applied to a radio frequency cable according to yet another embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

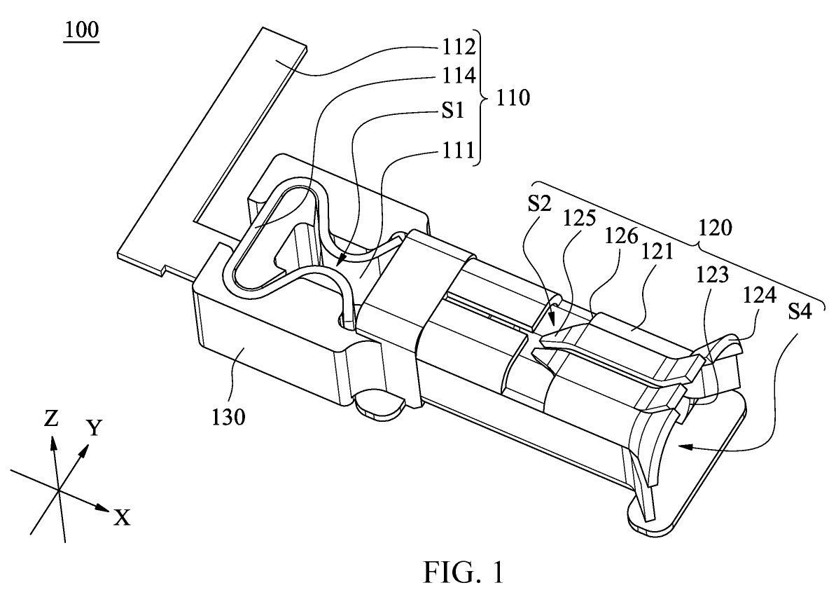

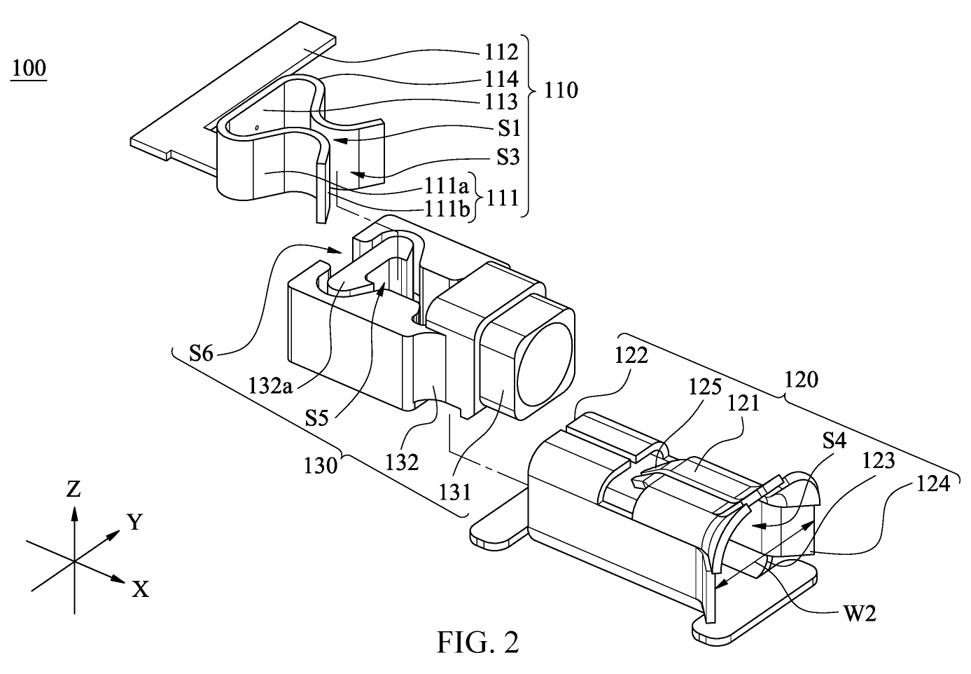

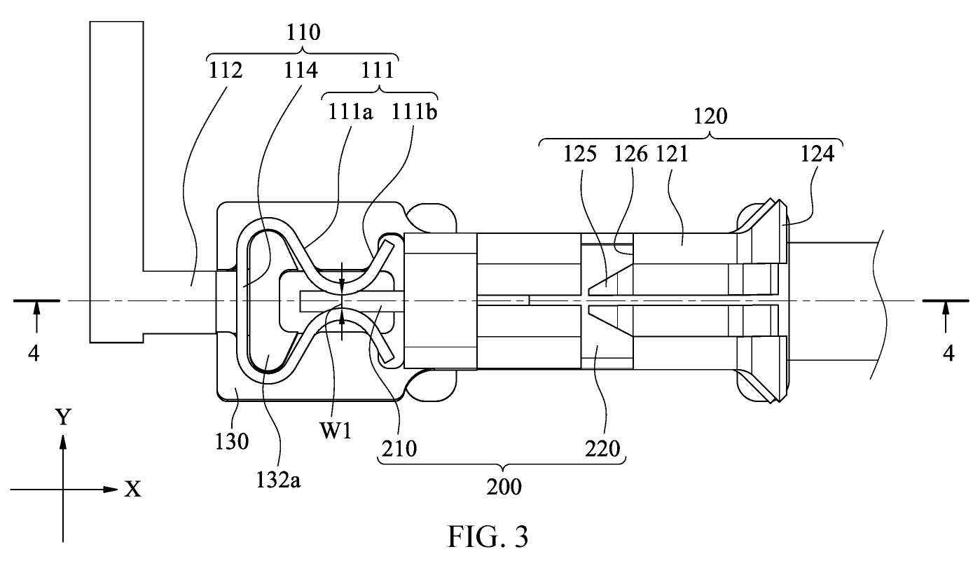

Referring to FIG. 1 to FIG. 3, FIG. 1 is a perspective view of a radio frequency connector 100 according to an embodiment of the present disclosure. FIG. 2 is an exploded view of the radio frequency connector 100 of the embodiment shown in FIG. 1. FIG. 3 is a top view of the radio frequency connector 100 connecting to a radio frequency cable 200 according to the embodiment shown in FIG. 1. The radio frequency connector 100 is configured to connect a radio frequency cable 200. The radio frequency cable 200 includes a core wire 210 and a metal covering layer 220 insulated from each other. The radio frequency connector 100 includes a first main body 110, a second main body 120, and an insulating body 130. The first main body 110 includes a first accommodating space S3 and a first opening S1. The first accommodating space S3 is configured to accommodate the core wire 210. The first opening S1 communicates with the first accommodating space S3, and the first opening S1 allows a first solder (reference is omitted) to enter the first accommodating space S3 to contact the core wire 210, thereby electrically connecting the core wire 210 with the first main body 110. The second main body 120 includes a second accommodating space S4 and a second opening S2. The second accommodating space S4 is configured to accommodate the metal covering layer 220. The second opening S2 communicates with the second accommodating space S4, and the second opening S2 allows a second solder (reference is omitted) to enter the second accommodating space S4 to contact the metal covering layer 220, thereby electrically connecting the metal covering layer 220 with the second main body 120. The insulating body 130 connects the first main body 110 and the second main body 120 to insulate the first main body 110 and the second main body 120 from each other.

Therefore, through the first main body 110, the core wire 210 can be connected to a first solder point of a radio frequency component, and through the second main body 120, the metal covering layer 220 can be connected to a second solder point of the radio frequency component without additional bending, solving the problem of low production efficiency caused by the manual bending step. The radio frequency component can be an antenna, the first solder point can be the signal feed point of the radio frequency cable 200, and the second solder point can be the ground connection point of the radio frequency cable 200.

The radio frequency cable 200 may further include a protective covering layer (reference is omitted) and an insulating covering layer (reference is omitted). The radio frequency cable 200 includes, from the outside to the inside, the protective covering layer, the metal covering layer 220, the insulating covering layer, and the core wire 210. The protective covering layer is made of an insulating material to prevent external impurities or electrical component interference. The metal covering layer 220 can be a metal braided mesh, which not only transmits radio frequency signals but also provides better strength characteristics for the radio frequency cable 200. The core wire 210 can transmit radio frequency signals. The insulating covering layer is configured to insulate the metal covering layer 220 from the core wire 210, preventing electrical interference between the metal covering layer 220 and the core wire 210. The metal covering layer 220 and the core wire 210 can simultaneously transmit radio frequency signals separately. In the present embodiment, the protective covering layer, the metal covering layer 220, and the insulating covering layer are partially stripped to allow the core wire 210, originally covered by the protective covering layer, the metal covering layer 220, and the insulating covering layer, to be electrically connected to the first main body 110, and to allow the metal covering layer 220, originally covered by the protective covering layer, to be electrically connected to the second main body 120.

The first main body 110 may further include two arm parts 111, which are opposed to each other to define the first accommodating space S3 and the first opening S1. When the core wire 210 is positioned in the first accommodating space S3, it touches at least one of the arm parts 111. In other words, when the core wire 210 is positioned in the first accommodating space S3, it may touch only one of the arm parts 111 or touch both of the arm parts 111 simultaneously. However, in other embodiments, the core wire may not touch any arm part, and the above disclosure should not be considered limiting.

Specifically, the first main body 110 is made of a metal material and is conductive. The first main body 110 may further include a connecting section 113, with the two arm parts 111 respectively connected to the two ends of the connecting section 113. The two arm parts 111 are arcuate and include an inwardly retracted section 111a and an outwardly expanded section 111b. The two arm parts 111 are mirror-symmetrical along an X-axis direction, with the inwardly retracted sections 111a retracted towards each other along a Y-axis, and the outwardly expanded sections 111b extending further away from the connecting section 113 along the X-axis than the inwardly retracted sections 111a. In other embodiments, the arm parts can be configured in other shapes as required, such as a U-shape, an L-shape, triangular configurations, etc., without being limited to the disclosure. As shown in FIG. 1, the connecting section 113 and the two arm parts 111 are formed by bending a first metal plate. The part of the first metal plate that is not bent and is parallel to the Y-axis forms the connecting section 113, while the bent parts of the first metal plate respectively form the two arm parts 111. The first metal plate has two edges 114 along a Z-axis, and one of the edges 114 (the edge 114 on the upper side along the Z-axis) at the corresponding inwardly retracted section 111a can define the first opening S1. The three-dimensional space between the inwardly retracted sections 111a along the Z-axis can be defined as the first accommodating space S3, which communicates with the first opening S1.

A minimum width W1 between the two arm parts 111 is greater than or equal to 0.2 mm. The minimum width W1 refers to the minimum distance between the inwardly retracted sections 111a parallel to the Y-axis. The diameter of the core wire 210 can be between 0.2 mm to 2 mm. Therefore, when the minimum width W1 is equal to the diameter of the core wire 210, the inwardly retracted sections 111a of the two arm parts 111 can slightly touch the core wire 210 without compressing it, preventing deformation or buckling of the core wire 210. When the minimum width W1 is slightly greater than the diameter of the core wire 210, it can help prevent deformation or buckling of the core wire 210 when entering the first accommodating space S3 and also help prevent poor soldering due to excessive spacing between the two arm parts 111 and the core wire 210.

The first main body 110 may further include a patch terminal 112, with one end of the patch terminal 112 electrically connected to the two arm parts 111, particularly through the connecting section 113 to indirectly connect to the two arm parts 111, thereby electrically connecting with the core wire 210. Another end of the patch terminal 112 is configured to electrically connect to the radio frequency component, and the patch terminal 112 can be configured to transmit signals from the radio frequency cable 200. Since there are various types of radio frequency cables 200 and radio frequency components, the soldering point locations for electrically connecting the radio frequency cable 200 and the radio frequency component may not be fixed. In the present embodiment, the patch terminal 112 can have different extension directions, allowing the selection of corresponding patch terminals 112 for different types of radio frequency components, achieving the purpose of not bending the radio frequency cable 200 or the radio frequency components. In the present embodiment, the patch terminal 112 can be L-shaped. In other embodiments, the patch terminal can be linear or horizontal, or can correspond to any extension direction of the radio frequency components, without being limited to the disclosure.

The second main body 120 may further include a tube wall 121, a first tube opening 122, a second tube opening 123, and a guiding part 124. The tube wall 121 surrounds the second accommodating space S4, and the second opening S2 penetrates the tube wall 121 to form an opening periphery 126. The first tube opening 122 is located at one end of the tube wall 121 and is adjacent to the first main body 110. The second tube opening 123 is located at another end of the tube wall 121. The guiding part 124 can be connected to the second tube opening 123, with a guiding part width W2 of the guiding part 124 gradually increasing towards one side that is away from the tube wall 121. The core wire 210 can sequentially pass through the second tube opening 123 and the first tube opening 122 along the guiding part 124 to enter the first accommodating space S3.

The second main body 120 can be formed by bending a second metal plate. One end of the second metal plate along the X-axis direction can have ribs separated by multiple grooves. When bent, the ribs can be bent outward to form the guiding part 124. The guiding part width W2 of the second main body 120 gradually increases in the direction away from the tube wall 121, meaning that the direction of entry of the radio frequency cable 200 into the radio frequency connector 100 is gradually narrowing. The guiding part 124 helps guide the radio frequency cable 200 into the second accommodating space S4 of the second main body 120 and prevents the radio frequency cable 200 from bending or buckling.

The second main body 120 may further include a hook part 125. The hook part 125 can be connected to the opening periphery 126 and is bent towards the second accommodating space S4 to limit the radio frequency cable 200. Specifically, the hook part 125 can be triangular, with one base edge integrally connected to the opening periphery 126. The opposite angle of the base edge is bent towards the second accommodating space S4. Besides limiting the radio frequency cable 200, when an external force is applied to pull the radio frequency cable 200 out of the radio frequency connector 100, the hook part 125 can block and prevent the radio frequency cable 200 from detaching.

The insulating body 130 is configured to connect the first main body 110 and the second main body 120, ensuring that they form independent components while being insulated from each other. The insulating body 130 can include a protruding part 131 and a setting part 132. The protruding part 131 extends into the first tube opening 122 to connect the insulating body 130 with the second main body 120. The setting part 132 is connected to the protruding part 131 and can include a setting space S5. The setting space S5 is configured to accommodate the two arm parts 111.

The insulating body 130 can be made of rubber, which is an insulator. The setting part 132 has a rectangular block structure and includes the setting space S5 with a shape corresponding to the connecting section 113 and the two arm parts 111. The insulating body 130 may further include a positioning block 132a. The positioning block 132a can be arranged in the setting space S5. Specifically, the positioning block 132a can be placed between the connecting section 113 and the inwardly retracted section 111a to help limit the first main body 110 and to restrict the first accommodating space S3, helping to concentrate the solder at the required position. The setting part 132 can include a protruding opening S6 located on the side away from the protruding part 131 and configured for the patch terminal 112 to extend therethrough. In other embodiments, if the height of the setting part along the Z-axis is greater than the height of the two arm parts, the setting part at the inwardly retracted section can be considered as an extension of the first opening and can allow the first solder to enter. The protruding part 131 extends from the setting part 132 towards the first tube opening 122 and matches with the first tube opening 122, allowing the protruding part 131 to be inserted into the first tube opening 122 to connect the insulating body 130 with the second main body 120.

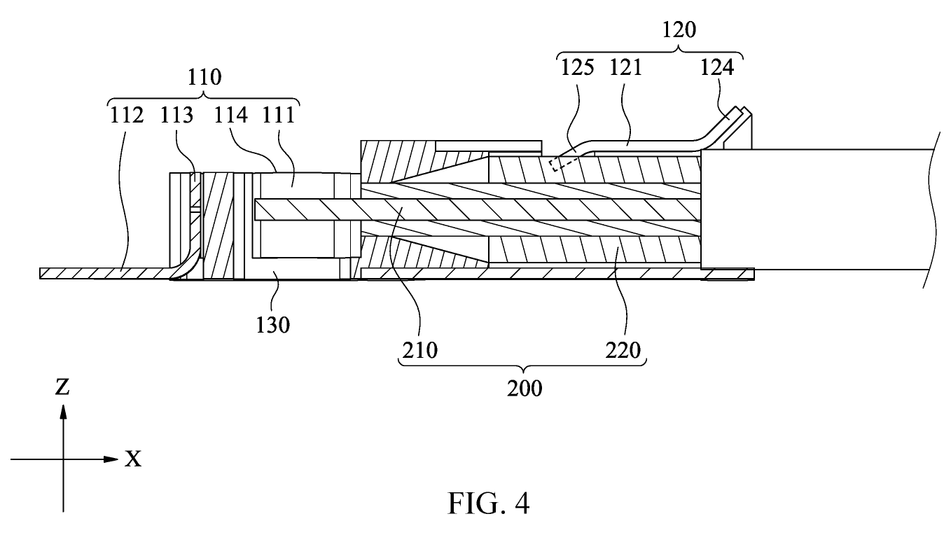

Referring to FIG. 4, along with FIG. 2 and FIG. 3, FIG. 4 is a cross-sectional view of the radio frequency connector 100 and the radio frequency cable 200 according to the embodiment shown in FIG. 1. After the radio frequency cable 200 is inserted into the radio frequency connector 100 along the guiding part 124, the core wire 210 enters the first accommodating space S3, and the metal covering layer 220 is positioned in the second accommodating space S4. The first opening S1 is arranged directly above the first accommodating space S3, allowing the first solder to vertically enter the first accommodating space S3 from the first opening S1 to electrically connect the first main body 110 with the core wire 210. The second opening S2 is arranged directly above the second accommodating space S4, allowing the second solder to vertically enter the second accommodating space S4 from the second opening S2 to electrically connect the second main body 120 with the metal covering layer 220. The configuration that allows the first solder and second solder to vertically enter from the outside makes the soldering process more intuitive and faster.

The first solder and the second solder are both conductors. By heating the first solder and the second solder to a molten state, the first solder adheres to both the first main body 110 and the core wire 210 in the molten state, and the second solder adheres to both the second main body 120 and the metal covering layer 220 in the molten state. After cooling, the first solder and the second solder solidify, such that the first solder electrically connects the first main body 110 with the core wire 210, and the second solder electrically connects the second main body 120 with the metal covering layer 220. In the present embodiment, the soldering method can be either mechanical automatic soldering or manual soldering, and the material of the first solder and the second solder can be tin, but it is not limited to this.

During the soldering process, the first solder and the second solder may react with oxygen, forming a metal oxide layer on the surface, which hinders the adhesion of the first solder to the first main body 110 and the core wire 210, and also hinders the adhesion of the second solder to the second main body 120 and the metal covering layer 220. Therefore, a flux (reference is omitted) can be added to prevent the formation of the metal oxide layer on the first solder and the second solder. The flux acts as a strong reducing agent at high temperatures, removing the metal oxide layer from the first solder and the second solder. In the present embodiment, the flux can be rosin or ammonium chloride, but it is not limited to this. In other embodiments, the flux can be any substance with metal reducing properties.

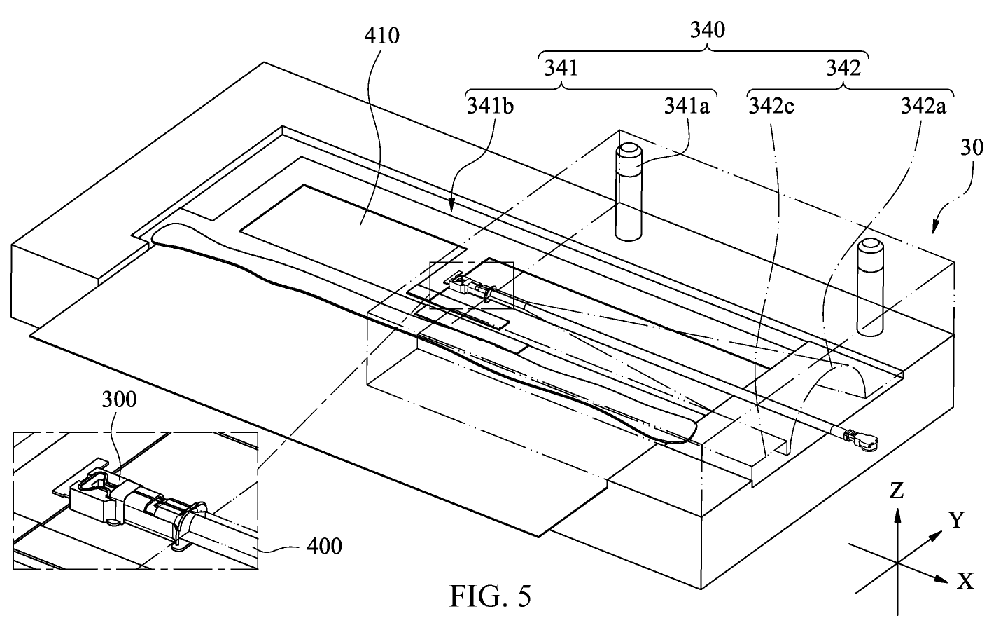

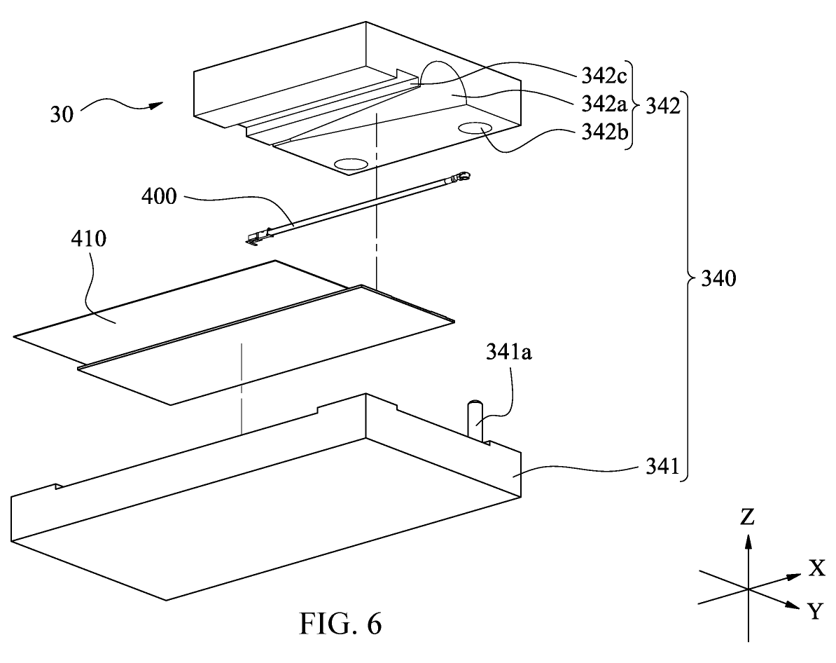

The radio frequency connector 100 can be soldered to the radio frequency component first. Specifically, the radio frequency component can be an antenna and include a radiation part and a grounding part. The patch terminal 112 of the first main body 110 can be soldered to the first solder point using surface mount technology to electrically connect to the radiation part, and the second main body 120 can be soldered to the second solder point to electrically connect to the grounding part. Then, the radio frequency cable 200 is directly inserted into the radio frequency connector 100, and through the first solder and second solder, the first main body 110 and the second main body 120 are respectively electrically connected to the core wire 210 and the metal covering layer 220. This fixes the soldering position and eliminates the step of bending the radio frequency cable 200. It should be noted that although the radio frequency component is not shown in the present embodiment, if the radio frequency component is an antenna, it can be similar to the radio frequency component 410 in FIG. 5 and FIG. 6. In other embodiments, the radio frequency component can be a power amplifier or an electrical transmission device without being limited to this.

Referring to FIG. 5 and FIG. 6, FIG. 5 is a perspective view of a radio frequency connection device 30 applied to a radio frequency cable 400 and a radio frequency component 410 according to another embodiment of the present disclosure. FIG. 6 is an exploded view of the radio frequency connection device 30 applied to the radio frequency cable 400 and the radio frequency component 410 according to the embodiment shown in FIG. 5. The radio frequency connection device 30 can include a radio frequency connector 300 and a jig body 340. The jig body 340 can include a base 341 and a cover 342. The base 341 can include a placement area 341b for placing the radio frequency component 410 and the radio frequency cable 400. The cover 342 is connected to the base 341 and can include an upper introduction groove 342a facing the base 341, with a depth of the upper introduction groove 342a gradually narrowing toward the radio frequency connector 300. The radio frequency cable 400 enters the radio frequency connector 300 along the upper introduction groove 342a. The radio frequency cable 400 is the same as the radio frequency cable 200, the radio frequency connector 300 is the same as the radio frequency connector 100, and the details will not be repeated.

The base 341 can be a square block structure, with a part recessed to form the placement area 341b, and the cover 342 can also be a square block structure corresponding to the base 341. A depth of the upper introduction groove 342a refers to the depth along a Z-axis direction, and the upper introduction groove 342a is an oblique tapered groove that narrows toward the radio frequency connector 300 along an X-axis direction. The upper introduction groove 342a can be configured to guide the radio frequency cable 400 into the radio frequency connector 300 along the X-axis direction and prevent the radio frequency cable 400 from bending or buckling.

In the embodiment shown in FIG. 5, a minimum depth of the upper introduction groove 342a can be greater than 3.5 mm. Since the diameter of the radio frequency cable 400 ranges from 0.8 mm to 3.5 mm, radio frequency cables 400 with different diameters can be guided into the radio frequency connector 300 through the upper introduction groove 342a.

The cover 342 may further include positioning holes 342b located on one side of the upper introduction groove 342a, and the base 341 includes positioning protrusions 341a to be inserted into the positioning holes 342b. The positioning holes 342b and the positioning protrusions 341a correspond to each other and the cover 342 and the base 341 can be detachably connected. In the present embodiment, the number of positioning protrusions 341a is two, and each positioning protrusion 341a is a cylinder. The number of positioning holes 342b is two, and each positioning hole 342b is a cylindrical space. The positioning protrusions 341a and the positioning holes 342b correspond to each other. In other embodiments, the positioning protrusions and positioning holes can be other shapes that allow the positioning protrusions to be inserted into the positioning holes, and the number of positioning protrusions and the number of the positioning holes can also be adjusted according to different needs.

The cover 342 may further include an anti-collision groove 342c located on another side of the upper introduction groove 342a. Since the radio frequency component 410 may have parts protruding along the Z-axis direction, the cover 342 may come into contact with the radio frequency component 410 placed in the placement area 341b when the cover 342 covers the base 341. The anti-collision groove 342c reduces the likelihood of the radio frequency component 410 colliding with the cover 342, thereby reducing the damage rate of the radio frequency component 410.

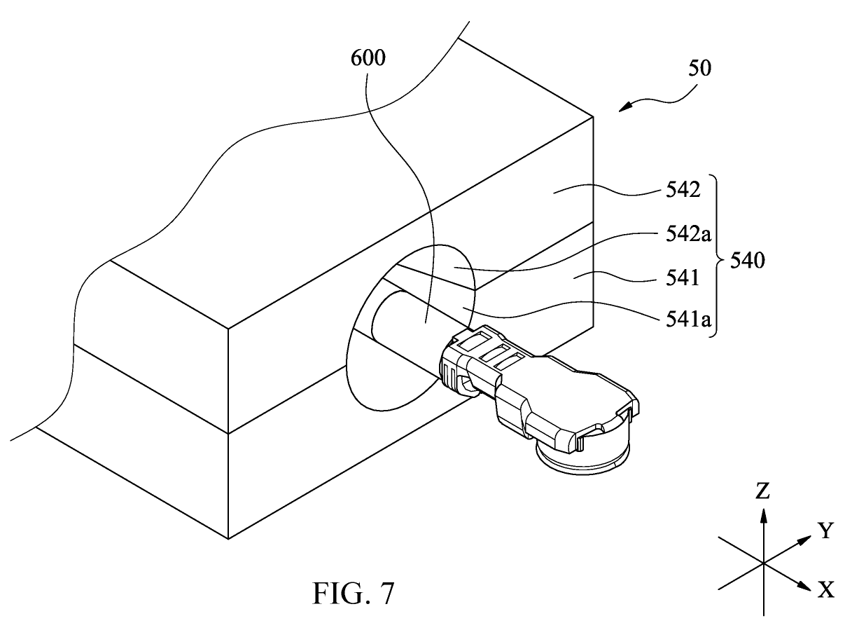

Referring to FIG. 7, FIG. 7 is a perspective view of a radio frequency connection device 50 applied to a radio frequency cable 600 according to yet another embodiment of the present disclosure. The radio frequency connection device 50 is similar to the radio frequency connection device 30, but in the radio frequency connection device 50, the base 541 of the jig body 540 may further include a lower introduction groove 541a. The lower introduction groove 541a corresponds to the upper introduction groove 542a of the cover 542 and forms a tapered hole. In the present embodiment, the lower introduction groove 541a and the upper introduction groove 542a work together to guide the radio frequency cable 600 into the radio frequency connector along an X-axis direction, preventing the radio frequency cable 600 from bending or buckling.

From the above embodiments, the present disclosure has the following advantages. First, the core wire can be connected to the first solder point of the radio frequency component through the first main body, and the metal covering layer can be connected to the second solder point of the radio frequency component through the second main body without additional bending, solving the problem of low production efficiency caused by the manual bending step. Second, the patch terminal can correspond to any extension direction of the radio frequency component, solving the problem of the solder point location for electrically connecting the radio frequency cable and the radio frequency component being potentially unfixed. Third, the jig body helps guide the radio frequency cable into the radio frequency connector and prevents the radio frequency cable from bending or buckling.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A radio frequency connector for connecting a radio frequency cable, the radio frequency cable comprising a core wire and a metal covering layer insulated from each other, the radio frequency connector comprising:
a first main body, comprising:
a first accommodating space for accommodating the core wire; and
a first opening communicating with the first accommodating space, the first opening allowing a first solder to enter the first accommodating space to contact the core wire, thereby electrically connecting the core wire with the first main body;
a second main body, comprising:
a second accommodating space for accommodating the metal covering layer; and
a second opening communicating with the second accommodating space, the second opening allowing a second solder to enter the second accommodating space to contact the metal covering layer, thereby electrically connecting the metal covering layer with the second main body; and
an insulating body connecting the first main body and the second main body to insulate the first main body and the second main body from each other.

2. The radio frequency connector according to claim 1, wherein the first main body further comprises two arm parts that are opposed to each other to define the first accommodating space and the first opening.

3. The radio frequency connector according to claim 2, wherein when the core wire is positioned in the first accommodating space, the core wire touches at least one of the two arm parts.

4. The radio frequency connector according to claim 2, wherein when the core wire is positioned in the first accommodating space, the core wire does not touch the two arm parts.

5. The radio frequency connector according to claim 2, wherein a minimum width between the two arm parts is greater than or equal to 0.2 mm.

6. The radio frequency connector according to claim 2, wherein the first main body further comprises a patch terminal, and the patch terminal is electrically connected to the two arm parts.

7. The radio frequency connector according to claim 2, wherein the second main body further comprises:
a tube wall surrounding the second accommodating space, the second opening penetrating the tube wall to form an opening periphery;
a first tube opening located at one end of the tube wall and adjacent to the first main body;
a second tube opening located at another end of the tube wall; and
a guiding part connected to the second tube opening, with a guiding part width of the guiding part gradually increasing towards one side that is away from the tube wall;
wherein the core wire sequentially passes through the second tube opening and the first tube opening along the guiding part to enter the first accommodating space.

8. The radio frequency connector according to claim 7, wherein the second main body further comprises a hook part, and the hook part is connected to the opening periphery and is bent towards the second accommodating space to limit the radio frequency cable.

9. The radio frequency connector according to claim 7, wherein the insulating body comprises:
a protruding part extending into the first tube opening to connect the insulating body with the second main body; and
a setting part connected to the protruding part and comprising a setting space for accommodating the two arm parts.

10. A radio frequency connection device applied to connect a radio frequency cable and a radio frequency component, the radio frequency cable configured to electrically connect the radio frequency component and comprising a core wire and a metal covering layer insulated from each other, the radio frequency connection device comprising:
a radio frequency connector disposed on the radio frequency component and comprising:
a first main body, comprising:
a first accommodating space for accommodating the core wire; and
a first opening communicating with the first accommodating space, the first opening allowing a first solder to enter the first accommodating space to contact the core wire, thereby electrically connecting the core wire with the first main body; and
a second main body, comprising:
a second accommodating space for accommodating the metal covering layer; and
a second opening communicating with the second accommodating space, the second opening allowing a second solder to enter the second accommodating space to contact the metal covering layer, thereby electrically connecting the metal covering layer with the second main body; and
a jig body, comprising:
a base comprising a placement area for placing the radio frequency component and the radio frequency cable; and
a cover connected to the base, the cover comprising an upper introduction groove facing the base, with a depth of the upper introduction groove gradually narrowing toward the radio frequency connector;
wherein the radio frequency cable enters the radio frequency connector along the upper introduction groove.

11. The radio frequency connection device according to claim 10, wherein the first main body further comprises two arm parts that are opposed to each other to define the first accommodating space and the first opening.

12. The radio frequency connection device according to claim 11, wherein when the core wire is positioned in the first accommodating space, the core wire touches at least one of the two arm parts.

13. The radio frequency connection device according to claim 11, wherein when the core wire is positioned in the first accommodating space, the core wire does not touch the two arm parts.

14. The radio frequency connection device according to claim 11, wherein a minimum width between the two arm parts is greater than or equal to 0.2 mm.

15. The radio frequency connection device according to claim 11, wherein the first main body further comprises a patch terminal, and the patch terminal is electrically connected to the two arm parts.

16. The radio frequency connection device according to claim 15, wherein the patch terminal is L-shaped.

17. The radio frequency connection device according to claim 10, wherein the radio frequency connector further comprises an insulating body connecting the first main body and the second main body to insulate the first main body and the second main body from each other.

18. The radio frequency connection device according to claim 10, wherein the cover further comprises a positioning hole located on one side of the upper introduction groove, and the base comprises a positioning protrusion configured to be inserted into the positioning hole.

19. The radio frequency connection device according to claim 18, wherein the cover further comprises an anti-collision groove located on another side of the upper introduction groove.

20. The radio frequency connection device according to claim 10, wherein the base further comprises a lower introduction groove, and the lower introduction groove corresponding to the upper introduction groove to form a tapered hole.
